(19) United States
(12) Patent Application Publication
(10) Pub. No.: US 2022/0305590 A1
(43) Pub. Date: Sep. 29, 2022

(54) LASER MACHINING DEVICE

(71) Applicant: Haute Ecole Arc, Neuchâtel (CH)

(72) Inventors: Yves SALVADÉ, St-Imier (CH); Philippe GRIZE, Neuchâtel (CH); Alain SCHORDERET, Cheseaux-Noréaz (CH)

(21) Appl. No.: 17/638,711

(22) PCT Filed: Aug. 26, 2020
(86) PCT No.: PCT/IB2020/057953

§ 371 Date: Feb. 25, 2022

(30) Foreign Application Priority Data
Aug. 29, 2019 (CH) 01087/19

(51) Int. Cl. B23K 26/388; B23K 26/384; B23K 26/073; B23K 26/0622; B23K 26/06; B23K 26/08

(52) U.S. Cl. CPC B23K 26/388; B23K 26/384; B23K 26/0734; B23K 26/0624; B23K 26/0648; B23K 26/0876

(57) ABSTRACT

Machining device comprising an optical trepanation head (1), comprising an opto-mechanical system having a head body (21) provided with a rotating device (22), a picosecond or femtosecond pulsed laser source (3), and at least one optical fiber (4) wherein the rotation device (22) of the opto-mechanical system (2) comprises a rotative diffraction grating (R1). Machining process by means of optical trepanation using such a device.

### TECHNICAL DOMAIN

The present invention relates to a laser machining device. In particular, it covers a picosecond or femtosecond pulsed laser machining device comprising an optical trepanning head.

### TECHNICAL BACKGROUND

The machining of deep holes thanks to the advent of picosecond or femtosecond lasers is well known; this technology allows shorter cycle times than with electroerosion technologies.

Laser spots, whose diameter corresponds to the diameter of the holes to be machined, are commonly used. However, this approach does not allow to control the draft angles.

The drilling method known as optical trepanning involves a circular movement of the laser beam around the circumference of the hole to be machined. The divergence of the laser beam on the surface of the workpiece causes a draft angle that must be compensated for by changing the incidence of the laser.

Currently used trepanning heads have galvanometric mirror arrays that allow the laser beam to be directed onto the workpiece. Other systems use rotating focusing optics based on prisms, such as Dove prisms, wedge prisms, or Abbe-Koenig prisms for example.

The refractive optical components, such as prisms, are however bulky and limit the compactness of optical trepanning heads. Their bulk is also a hindrance to the movements of these optical trepanning heads

There is therefore room for improvement in the trepanning process, particularly in terms of flexibility and speed.

### BRIEF SUMMARY OF THE INVENTION

The present invention proposes a compact optical trepanning device that can be easily oriented along several axes, in order to control the draft angles of the machined part. In particular, positive or negative draft angles can be obtained with great precision, whatever the shape to be machined.

An objective of the present invention is to provide a micromachining solution that is particularly suitable for profiles having a large height/diameter ratio. In particular, the present invention is suitable for machining parts where the height/diameter ratio is greater than 2, or even greater than 3 or 5. High precision mechanical parts such as injectors or spinning nozzles can then be machined. Holes with a diameter of between 50 micrometers and 1 millimeter can be machined using the present invention.

Another objective of the present invention is to provide a solution adaptable to a wide variety of materials, especially in relation to their thermal diffusion properties.

In particular, the micromachining device according to the present invention comprises an optical trepanning head, which comprises:

an opto-mechanical system, comprising a head body provided with a rotating device,

a picosecond or femtosecond pulsed laser source, and

at least one optical fiber.

The rotating device of the opto-mechanical system comprises a rotating diffraction grating, which may be of circular geometry. The thickness of the rotating grating is less than or equal to 1 millimeter. The diffractions of order 1 and −1 are mainly exploited through the rotating diffraction grating.

The rotating device according to the invention can be a commercially available spindle with a rotational speed of more than 180,000 rounds per minutes or even 200,000 rounds per minutes.

The opto-mechanical system of the device according to the present invention advantageously comprises a first lens, disposed between the laser source and the rotating device, the focal length of which may be variable. The opto-mechanical system may further comprise a second lens, disposed downstream of the rotating device and movable in translation along the longitudinal axis of the opto-mechanical system. The second lens may be conical. The opto-mechanical system may further comprise a last lens whose focal length is fixed. The last lens of the opto-mechanical system acts as a focusing lens. Between the second lens and the last lens, one or more other lenses can be arranged and possibly form a train of lenses

The present invention also relates to a method of machining by means of optical trepanning.

### BRIEF DESCRIPTION OF THE DRAWINGS

Embodiments of the present invention are mentioned in the description illustrated with the annexed figures:

FIG. 1: Schematical view of the trepanation head according to one embodiment of the present invention.

FIGS. 2a, 2b: Schematical view of the pathway of the laser beam according to two distinct modes.

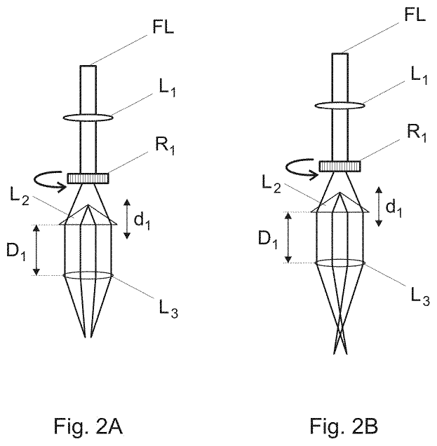

FIG. 3: Schematical view of a rotating diffraction grating used in the present invention.

FIGS. 4A, 4B, 4C, 4D: Examples of draft angles according to the incident angle of the laser beam on the part to be machined.

### EMBODIMENTS OF THE INVENTION

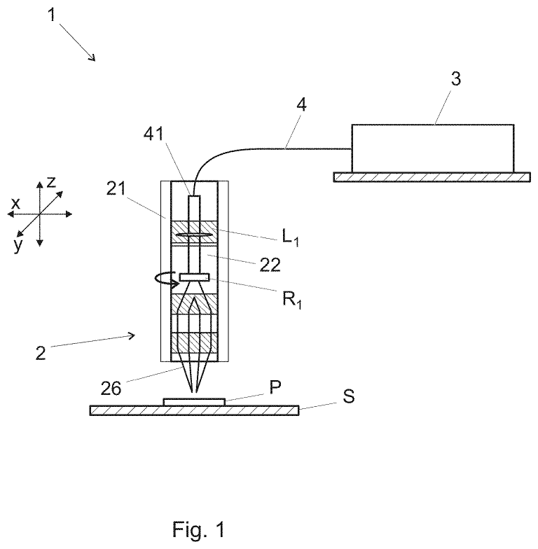

The present invention relates, for example, to a trepanning head 1 comprising an opto-mechanical system 2 and a laser source 3 as illustrated in FIG. 1. The opto-mechanical system 2 is connected to the laser source 3 by one or more optical fibers 4. The optical fiber 4 conducts the laser beam FL from the laser source 3 to the opto-mechanical system 2, to which it is connected via an optical connection 41. The optical fiber(s) 4 are preferably hollow and adapted to the light power of the laser source 3. The laser source 3 is preferably fixed. It is of picolaser or femtolaser type.

The optical trepanning head 1 is mobile along one of the axes x, y, or z, preferably along the two horizontal axes x and y. The device also includes a fixing support S aiming at holding the workpiece P to be drilled or machined. The support S can be arranged horizontally in a fixed manner. The optical drilling head 1, which is movable along the x and y axes, can then move over the surface of the workpiece P and drill holes at predetermined locations. Each drilling operation can also require a movement of the trepanning head 1 along the two axes x and y, allowing a circular movement of the trepanning head 1.

According to an alternative embodiment, the optical trepanning head 1 can be fixed and the support S can be mounted so as to be mobile along the two axes x and y in order to allow a rotational movement.

The optical trepanning head 1 or the holder S or both, can be further mounted so as to be movable along the z-axis. Workpieces of various thicknesses and shapes can then be machined.

According to an embodiment, the support 5 or the optical trepanning head 1, or both, can be furthermore mounted to rotate around at least one horizontal axis, such as x, or y, or both. In this way, machining can be performed at angles of incidence other than the right angle to the surface of the workpiece P.

The laser source 3 is a picosecond or femtosecond pulsed laser source. Such sources deliver a laser beam in pulses of duration less than about ten picoseconds, preferably less than 100 femtoseconds, or even less than 10 femtoseconds. Various picosecond and femtosecond laser sources are commercially available and known to the skilled person. Optical powers higher than 30 W, preferably equal or higher than 50 W are advantageously used. The energy of each pulse is greater than 100 microjoules, preferably greater than 500 microjoules.

The advantage of such a pulsed light source is that the energy useful for machining is limited to the point of impact of the laser beam FL, avoiding thermal transfer to the neighbouring zones. The material surrounding the impact of the FL laser beam is therefore not damaged, which allows a high quality of drilling and machining, as well as a wide variety of materials that can be machined.

The opto-mechanical system 2 comprises a head body 21, in which the various opto-mechanical elements are assembled. In this case, the head body 21 comprises a central space allowing the passage of a laser beam FL and its guidance through the opto-mechanical elements contained in the opto-mechanical system 2, from the optical fiber(s) 4 to its impact on the workpiece P to be machined. Several opto-mechanical elements are arranged in the path of the laser beam FL between the optical fiber connection 41 and the end 26, opposite the optical fiber connection, of the head body 21. The opto-mechanical system 2 thus comprises a longitudinal axis corresponding globally to the path of the laser beam FL.

According to an embodiment, the head body 21 comprises a first lens L1, a pin 22 containing a rotating diffraction grating R1, a second lens L2 and a last lens L3. The last lens L3 is arranged at the end 26 of the head body 21. The laser beam FL emitted from the optical fiber 4 passes through the first lens L1, then the pin 22, then through the second L2 and last lens L3. The arrangement of the first L1, second L2, and last L3 lenses is such that the second lens L2 is downstream of the first lens L1 and upstream of the last lens L3.

The terms “upstream” and “downstream” are defined throughout the text with respect to the direction of propagation of the laser beam FL. Any element located upstream of another element will be impacted by the laser beam FL before it. Any element located downstream of another element will be impacted by the laser beam FL after it.

The purpose of the first L1, second L2, and last L3 lenses is to converge the laser beam FL at concentrated points so as to focus its energy. The focal length of each of the first L1, second L2 and last L3 lenses, can be predetermined or variable.

The position of each of the first L1, second L2, and last L3 lenses relative to each other may be predetermined or variable. Each of the lenses may be arranged within the head body 21 on lens holders that may be fixed or movable. A lens holder may be translatable along the path of the laser beam FL or rotatable along one or more of the x or y axes, so as to vary the direction of the path of the laser beam FL. The movable lens holders can be motorized and controlled according to the objectives. They allow precise adjustments of the laser beam FL and its impact on the workpiece P. One or more intermediate lenses (not shown) can be provided between the second L2 and last L3 lenses. They can be independently of each other fixed or mobile in translation along the trajectory of the laser beam FL, or in rotation along one or more of the x or y axes.

According to an embodiment, the first lens L1 has a variable focal length. The position of the focusing plane PL1 corresponding to the focal length of the first lens L1 can therefore be modified, either before the machining operation or during the machining operation. A lens allowing an easy and fast variation of its focal length is therefore advantageously used. For example, a liquid lens such as those developed by the company Varioptic and described in patents EP 1870742, EP1662276, WO2007113637 can be used for this purpose. The speed of focusing of the lens allows an almost instantaneous adjustment of the focusing plane.

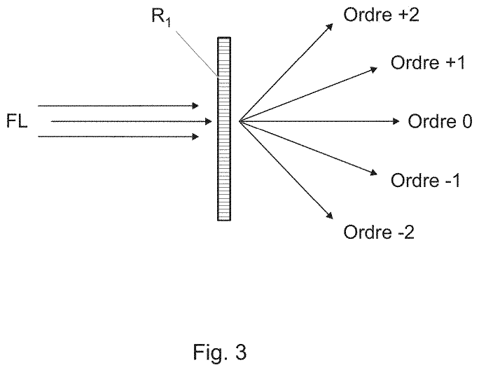

The laser beam FL then passes through the rotating diffraction grating R1 contained in the pin 22. The rotating diffraction grating R1 is the only rotating opto-mechanical element in the opto-mechanical system 2. The rotating diffraction grating R1 is shown in FIG. 3. It allows deflecting light from the laser beam FL in predefined directions, known as diffraction orders. Commercially available rotating diffraction gratings R1 can be used. For example, the phase grating type R1 diffraction gratings, known for their excellent diffraction efficiency, can be used.

The diffraction grating is preferably a phase grating, the relief of which is either continuous (e.g., sinusoidal) or composed of a limited number of height levels (binary or multi-level). Preferably, the diffraction orders +1 and −1 will be exploited, and the geometry of the phase grating must allow to obtain a maximum of diffraction efficiency in these two orders. Alternatively, other grating geometries allowing to exploit higher diffraction orders can be used.

The rotating diffraction grating R1 is a very compact component. It can be for example composed of a grating of lines, of micrometric size on a glass plate of less than 1 mm thickness. The rotary diffraction grating R1 is circularly symmetrical and light. It can therefore be advantageously associated with an ultra-high speed spindle 22. Such a spindle can rotate at a speed of the order of 180,000 rounds per minutes, 200,000 rounds per minutes, 300,000 rounds per minutes or more. The characteristics of the rotating grating R1 allow an optimal balancing of the spindle 22 during its rotation. The small size of the R1 diffraction grating reduces the size of the spindle 22 and attenuates possible defects.

The use of such a rotating diffraction grating R1 makes it possible to remain slightly sensitive or even insensitive to possible translational movements. The possible defects of the spindle 22, in particular those impacting the circularity of the movement will thus be attenuated or invisible.

The rotating grating R1 being very thin, the impact of any angular shift will be significantly mitigated compared to other arrangements incorporating prisms or mirrors. In particular, an angular shift of the rotating diffraction grating R1 up to 30 mrad can be tolerated in the device according to the present invention.

The spindle 22 is designed to rotate at a speed greater than 180,000 revolutions per minute, preferably greater than 300,000 revolutions per minute and more preferably greater than 500,000 revolutions per minute. It may be, for example, an industrial micro-drilling spindle such as the MUHD spindle rotating at 500,000 revolution per minutes with a drilling rate of 21 Hz. Alternatively, it can be a gas micro-turbine. An example of spindles 22 based on a hybrid aerodynamic/aerostatic bearing combination, described in patent application CH 710 120, can be used for this purpose. Other spindles intended, for example, for micro-machining can be used in the context of the present invention.

According to an embodiment, the second lens L2 is of the conical type, making it possible to shape the laser beam FL in the form of rings or hollow cylinders. In particular, the second lens L2 may be of the “axicon” type. The second lens L2 is preferably mounted on a lens holder that is movable (not shown) in translation along the head body 1. In other words, the second lens L2 is movable along the longitudinal axis of the opto-mechanical system 2. The laser beam FL coming from the rotating diffraction grating R1, passes through the second lens L2, designed to produce a ring or hollow cylinder shaped laser beam. The vertical displacement of the second lens L2 over a distance d1 allows to modulate the distance D which separates it from the last lens L3.

According to an embodiment, the second lens L2 can have a conical shape. The tip of the cone of such a lens, depending on its properties and the needs of the device, can be oriented towards the laser source or towards the last lens L3.

According to an embodiment, the second lens L2 may comprise a set of several lenses.

The last lens L3 is preferably mounted on a fixed support between the second lens L2 and the end 26 of the head body 21. The focal length of the last lens L3 is preferably predetermined. The last lens L3 is preferably convergent.

According to the arrangement of the optical trepanning head 1, the focal length of the first lens L1 and the position of the second lens L2 can be varied, either in terms of presettings before the micromachining operation or during the machining process.

According to an embodiment, the focal length and position of the first lens L1 and the position of the second lens L2 can be modulated, either in terms of presettings before the machining operation, or during machining.

The impact of the laser beam FL on the workpiece P to be machined can take the form of a single point with a diameter of about 20 micrometers. Depending on the adjustment parameters used, in particular those relating to the focal length of the first lens L1 and the position of the second lens L2, the impact of the laser beam FL, when the spindle 22 is not rotating, may take the form of two points with a diameter of the order of 20 micrometers. The spacing of the two light points on the surface of the workpiece P to be machined depends in particular on the position of the second lens L2.

The optical trepanning head 1 according to the present invention has the advantage of being compact. In particular, the opto-mechanical system 2 of the optical trepanning head 1 has a hindrance smaller than a cylinder of 50 mm diameter and 200 mm length. The trepanning head can then be easily mounted on translation and rotation axes.

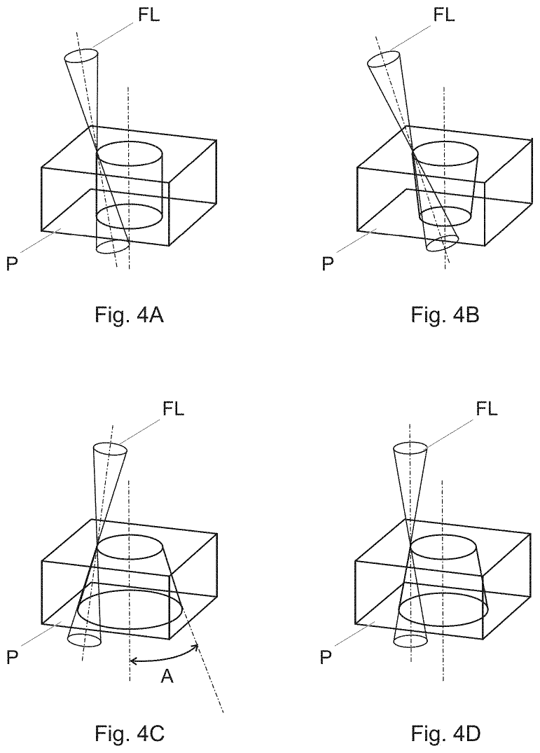

The draft angles A can be positive, as shown in FIGS. 4A and 4B, or negative, as shown in FIGS. 4C and 4D. A negative draft angle A of 0° to 5° can be achieved.

Another object of the present invention is an optical trepanning machining method for controlling the draft angles A of a workpiece P being machined. The draft angle A may be straight, as shown in FIG. 4A for example. In this configuration, the edges of the hole in the machined part P are perpendicular to its outer surface. In other words, the hole is cylindrical. The draft angle A can be positive, as shown in FIG. 4B. In this case, the hole forms a tapered section in the machined part P where the diameter of the top surface is greater than the diameter on the bottom surface of the part P. The top surface of the workpiece P is understood to be the surface on which the laser beam FL is incident. The lower surface of the part P is the opposite surface, which rests on the support S. Alternatively, the draft angle A can be negative, as shown in FIGS. 4C and 4D. In this case, the hole forms a conical section in the workpiece P where the diameter of the upper surface is smaller than the diameter on the lower surface of the workpiece P. The draft angle A is not directly representative of the angle of incidence of the laser beam FL on the top surface of the workpiece P. An incidence of the laser beam orthogonal to the top surface of the workpiece P does not produce a straight draft angle A, but a negative draft angle A, as shown in FIG. 4D. The right draft angle A is obtained by means of an inclined incidence of the laser beam FL on the top surface of the workpiece P, as shown in FIG. 4A. In this case, the incidence of the laser beam FL on the top surface of the workpiece P must be positive, i.e., directed toward the inside of the hole being machined. As the positive angle of incidence of the laser beam FL on the top surface of the workpiece P increases, then the draft angle A becomes positive, as shown in FIG. 4B. When the angle of incidence of the laser beam FL on the top surface of the workpiece P is negative, as shown in FIG. 4C, the draft angle A becomes negative.

The process includes a step of focusing a picosecond or femtosecond pulsed laser beam FL on the workpiece P to be machined. The laser beam FL is focused on the workpiece P by means of the optical trepanning head 1 described above.

The method comprises a step of initiating a precessional motion of the laser beam FL by means of a rotating diffraction grating R1. The rotational speed of the rotating diffraction grating R1 is 180,000 revolutions per minute or more. The rotational speed of the rotating diffraction grating R1 can be adapted to the pulse frequency of the laser beam FL and to the machining requirements, in particular to the diameter of the hole to be machined in the workpiece P. An increased rotational speed enables faster machining. In particular, the rotating diffraction grating R1 can be integrated with a spindle 22 as described above. The precessional movement of the laser beam FL allows the laser beam FL to form a circle of a given diameter on the top surface of the workpiece P.

The method according to the present invention comprises a step of modulating the distance of the second lens L2, that is translatable, with respect to the rotating diffraction grating R1. The second lens L2 may be movable over a distance d1. The distance D between the second lens L2 and the last lens L3 can then vary from a minimum distance Dm to a maximum distance DM. The minimum distance Dm and maximum distance DM, as well as the distance d1, can be adapted according to the properties of the second lens L2, in particular according to the diffraction angle and the deflection angle which characterize the second lens L2.

The distance separating the second lens L2 from the rotating diffraction grating R1 makes it possible to modulate the distance separating the two laser beams at the output of the second lens L2, generated for example by the diffraction orders +1/−1 of the rotating diffraction grating R1. Downstream of the lens L3, the angle of incidence of the laser beams resulting from these +1/−1 diffraction orders on the workpiece P is then adaptable. The laser beams FL resulting from the +1/−1 diffraction orders can be focused on the surface of the workpiece P at a point having a diameter of between 10 microns and 20 microns. Incidence orthogonal to the workpiece surface produces a negative draft angle A. Alternatively, the laser beams FL resulting from the +1/−1 diffraction orders are positively incident on the top surface of the workpiece P, thus forming a right or positive draft angle A. Alternatively, the laser beams FL resulting from the +1/−1 diffraction orders are negatively incident on the top surface of the workpiece P, thus forming a negative draft angle A.

The focusing of the laser beams resulting from the diffraction can be applied to diffraction orders other than +1 and −1. In particular, laser beams resulting from diffraction of higher orders can be focused on the surface of the workpiece to be machined.

### REFERENCE NUMBERS EMPLOYED IN THE FIGURES

A Draft angle
d1 Distance of movement of the second lens L2
D1 Distance between second and third lens
FL Laser beam
L1 First lens
L2 Second lens
L3 Third lens
P Workpiece
R1 Rotating diffraction grating
S Support for the workpiece
x,y,z Axes of orientation
1 Optical trepanation head
2 Opto-mécanical system
21 Head body
22 Spindle
26 End of the head body
3 Laser source
4 Optical fibre
41 Optical connexion

1. Machining device comprising an optical trepanning head, which comprises:
an opto-mechanical system, comprising a head body provided with a tip and a rotating device,
a picosecond or femtosecond pulsed laser source,
at least one optical fiber,
a first lens, and
a second lens,
wherein the rotating device of the opto-mechanical system comprises a rotating diffraction grating and wherein the second lens is arranged downstream the rotating device and is mobile in translation along the longitudinal axis of the opto-mechanical system.

2. Device according to claim 1, wherein the rotating diffracting grating has a circular geometry.

3. Device according to claim 1, wherein the rotating diffracting grating has a thickness lower than 1 millimetre.

4. Device according to claim 1, wherein the rotating diffracting grating is of the phase grating type.

5. Device according to claim 1, wherein the rotating device is a spindle, the rotation speed of which is higher than 180 000 revolution per minute.

6. Device according to claim 1, wherein the first lens is arranged between the laser source and the rotating device and in that its focal is variable.

7. (canceled)

8. Device according to claim 17, wherein said second lens is conical.

9. Device according to claim 1, wherein the opto-mechanical system comprises a last lens, arranged at the end of the head body, and having a fixed focal.

10. Process of optical trepanation comprising:
a step of focusing a picosecond or femtosecond pulsed laser beam on the top surface of a workpiece,
a step of controlling the incidence angle of the picosecond or femtosecond pulsed laser beam on said top surface of the workpiece,
a step of initiating a precessing movement of the laser beam on said top surface of the workpiece (P), allowing the laser beam defining a circular pathway.
